(19) United States
(12) Patent Application Publication
(10) Pub. No.: US 2009/0120168 A1
(43) Pub. Date: May 14, 2009

(54) MICROFLUIDIC DOWNHOLE DENSITY AND VISCOSITY SENSOR

(75) Inventors: Christopher Harrison, Auburndale, MA (US); Antoine Fornari, Boulogne-Billancourt (FR); Celine Giroux, Rembercourt (FR); Isabelle Etchart, Paris (FR); Dan E. Angelescu, Cambridge, MA (US); Seungoh Ryu, Newton Centre, MA (US); Kai Hsu, Sugar Land, TX (US); Jacques Jundt, Newton Highlands, MA (US); Hua Chen, Cambridge, MA (US); Matthew Sullivan, Belmont, MA (US); Anthony Robert Holmes Goodwin, Sugar Land, TX (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 11/937,078

(22) Filed: Nov. 8, 2007

(51) Int. Cl. G01N 11/10; G01N 9/00

(52) U.S. Cl. 73/54.24; 73/32 A

(57) ABSTRACT

The present invention recited a method and apparatus for providing a parameter of a fluid within a fluid channel using a MEMS resonating element in contact with the fluid moving through the fluid channel. Additionally an actuating device associated with the MEMS resonating element is further provided, such that the actuating device can induce motion in the MEMS resonating element. In communication with the MEMS resonating element is an interpretation element capable of calculating a parameter of the fluid moving through the fluid channel based upon data from the MEMS resonating element upon actuation by the actuating device.

### BACKGROUND OF THE INVENTION

1. Field of the Invention

The present invention relates generally to the measurement of a property of a fluid, and more particularly the measurement of a property such as but not limited to density or viscosity of a fluid in a reservoir. For the purpose of clarity the present invention addresses hydrocarbon reservoirs, but is applicable to a variety of reservoir applications. Knowledge of the physical properties of downhole fluids, such as viscosity and density, is beneficial in the economic appraisal and completion of a well.

2. State of the Art

Measurement of a physical property of a gas or liquid has numerous applications in residential and commercial setting. The physical properties of interest may be viscosity or density of the fluid. Physical property measurements, such as these, are central to a variety of industries and applications. Measurement of the physical properties of a homogeneous fluid may be beneficial in gas flows, liquid flows or flow of a system that contains a combination of substances that are both gas and liquid under standard temperature and pressure. Furthermore, the flow may be a single phase or multi-phase flow; for the latter the properties of each phase are determined. While these various flows span numerous applications, one such environment and application is the oil and natural gas industry.

In some applications within the oil and natural gas industry, knowledge of the physical properties of a fluid are beneficial in both surface based experiments as well as measurements conducted in a downhole environment. For example, in a hydrocarbon bearing reservoir setting the economic value of the hydrocarbon reserves, the efficiency of recovery, and the design of production systems all depend upon the physical properties of the reservoir hydrocarbon fluid. In such a setting, density and viscosity measurements are beneficial in firstly determining if it is economically viable to develop this reservoir, and, secondly to design and plan the reservoir development.

Additionally, in a downhole environment the naturally occurring hydrocarbon fluids may include dry natural gas, wet gas, condensate, light oil, black oil, heavy oil, and heavy viscous tar. Furthermore, there may be flows of water and of synthetic fluids, such as oils used in the formulation of drilling muds, fluids used in formation fracturing jobs etc. Each of these individual fluids presents vastly different physical properties, yet all may pass through a single flow channel for measurement. As general production of hydrocarbon fluids is almost always accompanied by the production of water; direct physical measurements on production fluid properties typically results in the measurement of a mixture of phases thereby resulting in a volume-averaged data. For a well producing 10 barrels of water for 1 barrel of oil, it is therefore a challenge to obtain the true viscosity of the hydrocarbon produced, as such measurements are typically dominated by the properties of the majority phase, namely that of water.

As the economic value of a hydrocarbon reserve, the method of production, the efficiency of recovery, the design of production hardware systems, etc., all depend upon a number physical properties of the encountered fluid, it is important that these physical properties are determined with an accuracy fit for the purpose for which the data will be used.

Additionally, in a production logging environment it is beneficial to have knowledge of the fluid properties of a flowing fluid at different places axially and radially in the production pipe so that one may have a proper understanding of oil production and well development. Ideally, a property measurement should cover a wide range of flow rates, should work irrespective of fluid composition or phase (oil, gas or water), and should provide a local measurement (so that a map of the flow across the borehole can be created). A useful addition to these elements would be the potential to apply the same measurement scheme in a miniaturized geometry, such as a micro fluidic device.

Several measurement principles have been attempted in the past to measure the physical properties of flowing fluids encountered in the hydrocarbon as well as and other industries. For example, there exist other techniques to measure the density and viscosity of fluids in a reservoir fluid, but each technique has associated weaknesses. One such technique uses NMR measurements wherein, the viscosity of reservoir fluids can be deduced from measurements of the t2 relaxation time, but without additional adjustable parameters for each oilfield, the accuracy is usually considered to be no better than an order of magnitude. The reservoir fluid density can be calculated by measuring the pressure at two depths, taking the difference, and dividing by the product of the depth difference and the acceleration of gravity. The intrinsic sources of error here consist of the assumption that the fluid is homogeneous as a function of height and differences are accurately known. For incompressible fluids the viscosity can be measured granted an accurately known flown rate and the pressure drop along a flow line, but flow rate measurements are notorious for being inaccurate, decreasing the accuracy of the viscosity measurement.

Furthermore, the state of the art technologies concerning MEMS and microfluidic parameter measurement of a fluid moving through a fluid channel are currently limited to those applications operating in relatively stable environments having ambient pressure and temperature conditions. Such techniques are therefore not applicable to operating environments such as those encountered in an oilfield setting which requires robust operation at temperatures up to 200 C and pressure below 20,000 psi, wherein these conditions would destroy conventional sensors.

Furthermore, for microfluidic devices wherein a resonating element is incorporated into in a microfluidic channel the phenomenon known as “squeeze film damping” may result in systematic errors in the data obtained. The motion of a resonating element immersed in a fluid near a solid wall requires that the fluid found between the element and the wall be displaced during each oscillation. The energy needed to displace this fluid near the wall imposes an additional energy loss on the vibrating element, thereby changing the resonance. In view of this, design criteria must be selected wherein this effect is minimized such that data accuracy is ensured.

In view of the foregoing limitations of traditional techniques, a measurement apparatus for providing a least one parameter of a fluid moving in a fluid channel using a resonating element is beneficial. Furthermore, the sizing and orientation of this resonating element in a manner such that squeeze film dampening effects are minimized is further required.

### SUMMARY OF THE INVENTION

The present invention recites a MEMS based method, system and apparatus to provide at least one parameter of a fluid moving through a fluid channel. The method, system and apparatus comprises a resonating MEMS element in contact with the fluid moving through the fluid channel. The MEMS resonating element may take numerous forms and shapes, including but not limited to a cantilever, double clamped beam or torsional paddle shape. Furthermore, the sizing and orientation of the MEMS resonating element within the fluid channel is such that the effects of squeeze film dampening are minimized. Furthermore, associated with the MEMS resonating element is an actuating device and an interpretation element, wherein the interpretation element is capable of providing a parameter of the fluid moving through the fluid channel based upon data from the resonating element upon actuation by the actuating device.

In accordance with the present invention, the fluid parameters provided by the interpretation element may be fluid density or viscosity. Additionally, the actuating device associated with the MEMS resonating element may be an electromagnetic field, piezo element, or a localized heating device such that the data provided by the resonating element is steady state or transient data. Using conventional definitions found in the scientific literature, we define a steady state measurement as one where the excitation or actuation frequency is swept from below to above the resonant frequency while the amplitude is measured at each frequency. We define a transient method as one where the resonator is delivered an impulse of energy and the oscillating amplitude is measured as a function of time. For either methodology, one such set of data may consist of the quality factor and frequency after proper interpretation.

The fluid channel of the present invention may further be a microfluidic channel and a separator for removing the aqueous component and may further be disposed within said fluid channel in a location upstream of the measurement apparatus of the present invention. Additionally, the measurement apparatus of the present invention may be pressure and temperature compensated such that changes in pressures and temperatures do no result in unacceptable decrease e in accuracy of the measured parameter.

### BRIEF DESCRIPTION OF THE DRAWINGS

FIG. 1 is an illustrative example of one embodiment of the present invention for use in measuring a fluid parameter of a flowing fluid;

FIG. 2 is an illustrative example of an alternative embodiment of the present invention for use in measuring a fluid parameter of a flowing fluid in a microfluidic channel;

FIG. 3A is a graphical representation of the typical deflection exhibited by an embodiment of the present invention as a function of frequency wherein steady state measurements are analyzed;

FIG. 3B is a graphical representation of the typical deflection exhibited by an embodiment of the present invention when transient measurements are used;

FIG. 4A is an illustrative embodiment of a suitable resonating element for use in practicing an embodiment of the present invention;

FIG. 4B-4D is a graphical representation of the temperature effects exhibited by the resonating element of FIG. 4a in accordance with one embodiment of the present invention;

FIG. 5A is an illustrative embodiment of an alternative measurement apparatus for use in practicing the present invention;

FIG. 5B is an illustrative embodiment of an alternative measurement apparatus for use in practicing the present invention;

FIG. 6 is an illustrative embodiment of an alternative measurement apparatus for use in practicing the present invention;

FIG. 7 is an illustrative embodiment of a Wheatstone bridge arrangement for use in practicing an embodiment of the present invention;

FIG. 8 contains two graphs from which a full viscosity and density solution can be obtained in accordance with one embodiment of the present invention;

FIG. 9 is a schematic diagram of a system for calculating a fluid parameter according to one embodiment of the present invention;

FIG. 10 is a flowchart illustrating the steps necessary in practicing one embodiment of the present invention.

### DETAILED DESCRIPTION OF THE INVENTION

Various embodiments and aspects of the invention will now be described in detail with reference to the accompanying figures. This invention is not limited in its application to the details of construction and the arrangement of components set forth in the following description or illustrated in the drawings. The invention is capable of various alternative embodiments and may be practiced using a variety of other ways. Furthermore, the terminology and phraseology used herein is solely used for descriptive purposes and should not be construed as limiting in scope. Language such as “including,” “comprising,” “having,” “containing,” or “involving,” and variations herein, are intended to encompass the items listed thereafter, equivalents, and additional items not recited. As used herein the term “fluid channel” shall include any element capable of containing a fluid regardless of cross sectional shape.

The present invention recites a MEMS apparatus, method and device for measuring properties of a flowing fluid. In the preferred embodiment of this invention, the parameter of interest may be fluid viscosity or density of the fluid. A MEMS device or a MEMS sensor refers to any micro electro mechanical system and it generically refers to batch fabrication using silicon and/or carbide micro-machining techniques, or similar technologies. While the present invention is applicable to a variety of single phase and multiphase fluids, for clarity a flowing hydrocarbon fluid will be discussed. Such a selection is not intended to be limiting in scope, as one skilled in the art will readily recognize that the methods and techniques of the present invention are applicable to a variety of industries, applications and fluids.

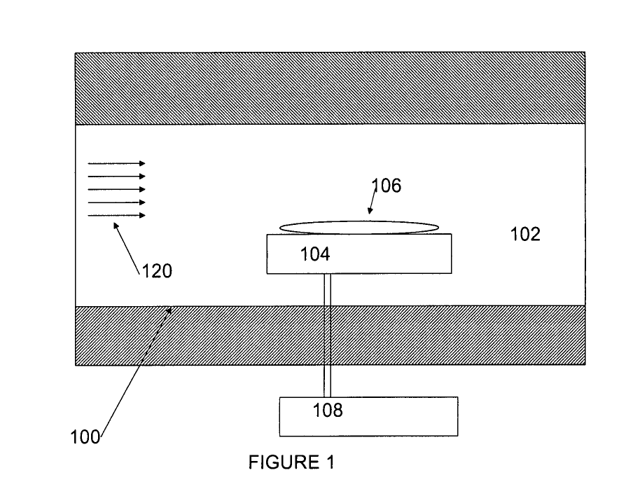

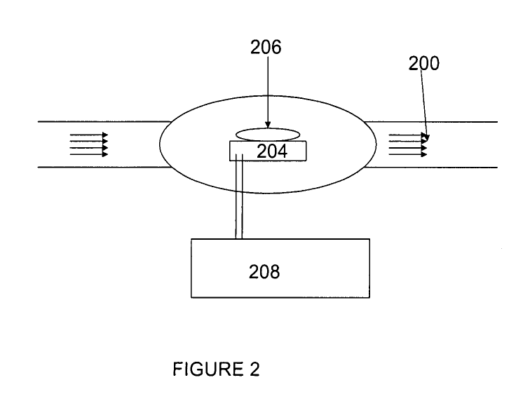

As illustrated in FIG. 1, a flowing fluid 102 contained within a fluid channel 100 is illustrated. In the present illustration, this fluid has a fluid direction 120. This flowing fluid may be a single phase fluid or may be a multi-phase fluid. Furthermore, the fluid channel 100 may be a macro fluid channel or may be a microfluidic fluid channel. For the purpose of clarity, the present invention will be described in relation to a microfluidic fluid channel, such as the microfluidic channel illustrated in FIG. 2. One skilled in the art will recognize that the present invention is readily applicable to a variety of fluid channels of varying size, shape and length. Disposed within the fluid channel 100 of the present invention is a resonating element 104, wherein said resonating element 104 is immersed in the fluid 102 moving through the fluid channel 100. Furthermore the resonating element 104 includes an actuating device 106 associated with the resonating element 104. Further associated with the resonating element 104 is an interpretation element 108 wherein said interpretation element provides a parameter of the fluid 102 moving through the fluid channel 100 based upon data from the resonating element 104 upon actuation by the actuation device 106. One skilled in the art will readily recognize that the present invention may be incorporated into a variety of fluid channels, including but not limited to an evaluation flowline in a downhole tool.

FIG. 2 is an illustration of the present invention practiced in a microfluidic setting. As set forth previously, the illustration of the present invention in a microfluidic setting is solely for illustrative purposes, and is not intended to be limiting in scope. FIG. 2 illustrates a measurement apparatus in accordance with one embodiment of the present invention, wherein the measuring apparatus is fabricated out of a single crystal silicon wafer. The apparatus of the present embodiment may be a MEMS structure. An apparatus such as this may be place within a microfluidic flowline of a downhole tool in accordance with an embodiment of the present invention.

The measurement apparatus includes a resonating element 204. In one embodiment of the present invention, this resonating element 204 may take the form of a thin vibrating plate that vibrates out of plane, much like a diving board. Fluid in the fluid channel 200 is passed through the resonating vibrating element 204 and connections for an actuating device 206 are further illustrated. In accordance with the present invention, the connections for the actuating device 206 are electrical connections used to deliver an electromotive force to the actuating device associated with the resonating vibrating element 204. Further associated with the resonating vibrating element 204 is an interpretation element 208, wherein said interpretation element is capable of providing a parameter of the fluid 202 in the fluid channel 200. In accordance with one embodiment of the present invention, the parameter provided is viscosity or density data. One skilled in the art will readily recognize that the recitation of density and viscosity is not intended to be limiting in scope of potential fluid parameters provided, as fluid parameters such as, but not limited to phase behavior may additionally be determined using the present invention. Such fluid parameters may further be utilized to evaluate potential reserves, determine flow in porous media and design completion, separation, treating, and metering systems, among others. Other parameters that might be measured are as follows: sound speed and absorption, complex relative electric permittivity, and thermal conductivity. One skilled in the art will also recognize that other actuation methods are possible, driven by for example heat or piezo actuation.

The application of a MEMS measuring device, in accordance with the present invention, provides for a means by which measurements may be performed within extremely small fluid-filled channels, such as those present in micro devices. In one embodiment of the present invention, a MEMS based measurement apparatus may be integrated with other existing sensors in a “lab on a chip” approach. Suitable “Lab on a Chip” systems are detailed in U.S. Patent Application Publication Number US-2006-0008382-A1, filed Jul. 6, 2004 and assigned to Schlumberger Technology Corporation, which is herein incorporated by reference. As recited earlier, however, the present invention is directly applicable to both macro and micro channels, and the illustrated MEMS device is not intended to be limiting in scope of the present invention. This said, for illustrated purposes a suitable MEMS arrangement will be discussed in greater detail below.

The present invention recites a measurement apparatus for providing at least one property (not parameter) of a fluid in a fluid channel, wherein the measuring apparatus includes a resonating element that is further actuated by an actuation element. Associated with the resonating element and actuation element is an interpretation element capable of proving at least one parameter of the flowing fluid. One skilled in the art will recognize that numerous suitable resonating elements may be utilized in practicing the present invention. For the purpose of clarity, several suitable resonating elements will be discussed in detail below. The recitation of these particular resonating elements used in practicing the present invention is solely for illustrative purposes and is not intended to be limiting in scope. Additionally, these suitable resonating elements may be employed in a micro or macro fluid channel setting. For illustrative purposes, the present invention will be described in a microfluidic setting. One skilled in the art will recognize that the present invention may be practiced in a variety of fluid channels on both a macro and micro fluidic level.

In accordance with one embodiment of the present invention, a vibrating structure may be utilized as a suitable resonating element. This vibrating structure may further be a MEMS structure, as understood by one skilled in the art. The MEMS structure may take numerous forms and may be manufactured using a variety of understood fabrication techniques and materials. For example, the MEMS structure may be manufactured from monocrystalline silicon and may take the form of a freely suspended beam, cantilever or diaphragm. As understood by one skilled in the art, monocrystaline silicon offers little internal damping and a high elastic modulus resulting in a suitable resonator element.

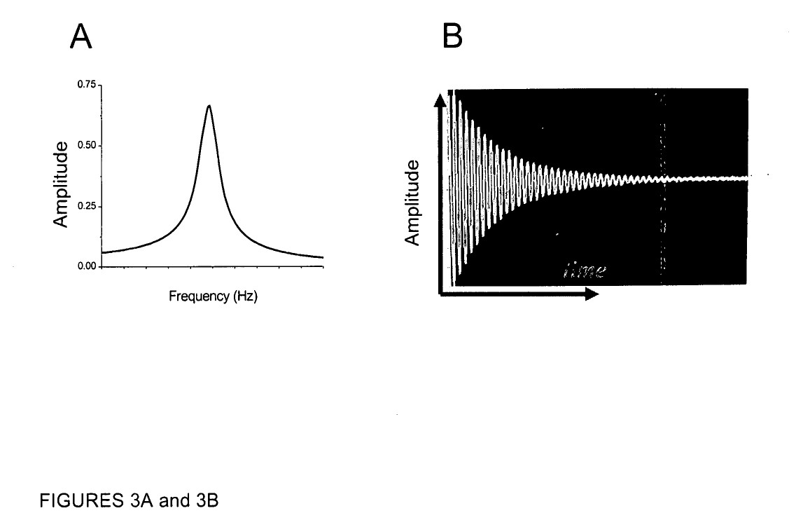

The resonating structures described above can be actuated by a variety of methods, such as by localized heating, excitation by a piezo crystal, or by an electromagnetic field. An actuated device then can be thought of as a driven, damped oscillator and treated classically. One simplified realization of this idea would be a silicon beam or plate with a thin coating of metal that could carry current. In the presence of a magnetic field oriented perpendicular to the beam, an oscillating current would produce an oscillatory driving force on the beam. This force would be proportional to the product of the current, the beam length, and the field strength. A driving frequency commensurate with the structure's resonance frequency would create the largest deflection (amplitude) of the beam. Deflection of the beam in the presence of the magnetic field produces a strain in the beam which is measurable by conventional techniques, such as with a strain gauge in the form of a Wheatstone bridge. A variation on this realization would include a piezo-resistant element to measure the deflection with a strain gauge. A typical deflection as a function of frequency is shown in FIG. 3A for steady state data and as a function of time in FIG. 3B.

The peak shown in FIG. 3A possesses a resonance frequency and quality factor (f,q), two resonance properties that are used by the interpretation element 208 of FIG. 2 to provide at least one parameter of a fluid moving through a fluid channel. Suitable fluid parameters include, but are not limited to fluid density and viscosity. One skilled in the art will readily recognize that numerous other fluid properties may be measured with the technique recited herein, including but not limited to bubble point. In accordance with the present embodiment, the general association between fluid density and resonance frequency is such that fluid density is roughly proportional to the inverse resonance frequency squared with suitable offset. In a similar fashion, the measured viscosity is roughly proportional to the inverse quality factor squared, wherein quality factor is defined as frequency divided by peak width for steady state data. One skilled in the art will recognize, however, that this is solely a broad generalization that is dependent on the actual structure (i.e. a cantilever or torsional paddle, for example). Furthermore these two effects are coupled, requiring more specific analysis based upon the geometry of the given vibrating structure.

The techniques and methods of the present invention may be additionally utilized with non-steady state data (i.e. transient data). An example of a transient data set, also referred to as a ringdown, is shown in FIG. 3B, wherein amplitude is shown to decrease as a function of time upon actuation of the resonating element using a suitable technique as understood by one skilled in the art. Using a ringdown technique such as this, the general relationship between amplitude and time is such that the amplitude decreases roughly exponentially with time in an oscillatory fashion. The number of oscillations before a decrease of 96% of the amplitude gives a measure of the quality factor (a unitless quantity). One skilled in the art will appreciate that this quality factor is similar to the unitless quality factor determined when using analyzing steady state data. One skilled in the art will further appreciate that the application of steady state date or transient data for analysis is generally governed by the details of the measurement apparatus and the operating environments, as well as additional aspects readily appreciated by one skilled in the art such that advantageous results are provided.

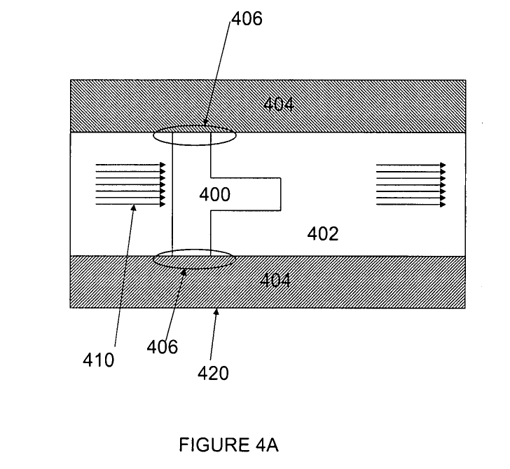

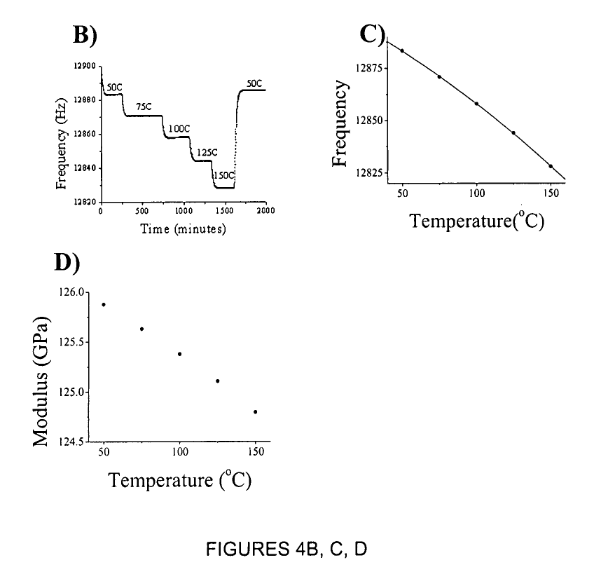

As noted earlier, one skilled in the art will recognize that numerous suitable MEMS structures exist which may be utilized in practicing the present embodiment. In accordance with one embodiment of the present invention, a resonating element such as a MEMS structure having a cantilever arrangement may be used. Such a cantilever arrangement is illustrated in FIG. 4A, wherein the cantilever 400 is clamped at only one location 406 within a flow channel 402, thereby exhibiting the properties of a singly clamped beam. In the present illustration, the cantilever resonating element 400 is clamped to a wall 404 of the flow channel 420. Additionally, the cantilever resonating element 400 is orientated to be exposed to a fluid flow 410 flowing through the flow channel 402. Such a cantilever resonating element 400 arrangement, as understood by one skilled in the art, exhibits a stable resonate frequency. The cantilever resonating element 400 of the present embodiment may be a MEMS device and may be located within a microfluidic channel in accordance with one embodiment of the present invention.

The cantilever resonating element 400 arrangement of the present embodiment offers several advantages as compared to alternate embodiments of MEMS devices, namely beneficial response when located in an environment having variable temperatures and pressures. As understood by one skilled in the art, the large temperature and pressure fluctuations encountered in an operating environment such as a downhole environment may affect the resonance frequency and quality factor of the resonating element. Such variations, if not properly compensated for, would result in a systematic error from the interpretation element. As the frequency and quality factor of the resonating element of the present embodiment must be stable or shift reproducibly with respect to temperature, the manufactured MEMS cantilevered resonating element must have a modulus that is either completely stable in spite of temperature shifts, or, short of that, have a shift of small magnitude that may be characterized. Manufacturing the MEMS cantilevered device from a single crystal without grain boundaries and largely free of defects, for example using high purity silicon, meets such needs. The temperature-dependent frequency shift of the cantilever oscillating in vacuum displays little hysteresis (FIG. 4B), and is easily compensated for by a second-order polynomial (FIG. 4C), provided the temperature is known from ancillary measurements. The modulus that can be calculated from such experiments indicates there is less than a 1% shift for a 100 K temperature change. The interpretation element can then incorporate the temperature dependence of the modulus into its working equations. Such ancillary measurements are commonplace in a variety of downhole tools wherein the present invention may be employed. Because the object is solid silicon, and the compressibility of this material is not high, the variation of the dimensions with pressure are not relevant for the accuracy of the measurements desired for the intended purpose of the oil field. For other applications the effect of pressure may need to be taken into account.

The resonating element having the form of a cantilevered vibrating structure may be actuated in a variety of ways, as understood by one skilled in the art. In the present embodiment, the cantilever element may be actuated by passing a current through the beam in the presence of a magnetic field oriented normal to the beam. The deflection can be measured by an on-board strain gauge or by measuring the resulting emf voltage. Such actuation element is not exhaustive of the suitable actuation element which may be employed with the present invention, and is solely illustrated for the purposes of clarity.

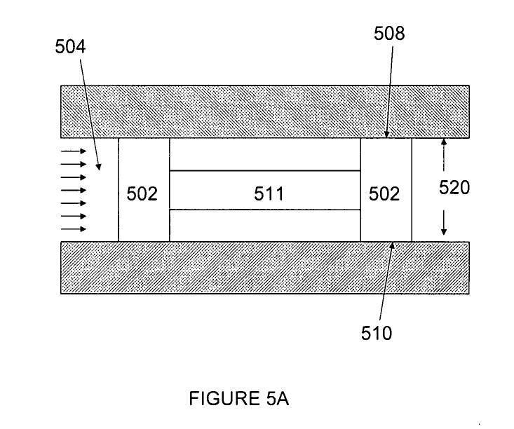

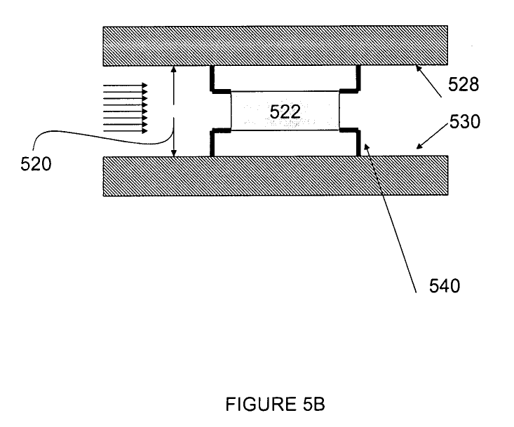

In comparison to the cantilever arrangement of FIG. 4, an alternative doubly clamped beam arrangement may be employed. Such an arrangement is illustrated in FIG. 5A. In contrast to the cantilever arrangement of FIG. 4, the resonating element having the form of a doubly clamped beam exhibits decreased performance when placed in an environment having temperature fluctuation and/or pressure fluctuations. As the present invention is not intended to be limited to downhole applications, and may be utilized in a variety of suitable applications, this may or may not be a concern. In the present embodiment of FIG. 5, shifts in pressure or temperature can alter the resonance frequency of a vibrating structure by altering the tension in the beam. For example, the portion of silicon beam that runs between 508 and 510 (502) will experience compression or elongation as the distance between the supports changes. The resonance frequency of this portion alone is therefore highly dependent upon temperature and pressure. However, the portion of the silicon beam running parallel to the channel, (511) would experience a much less pronounced strain, in effect decoupling it from such undesirable consequences. Hence by proper geometric design, one can minimize the effect on the resonance of a temperature and pressure dependent distance between the supports. This and similar decoupling techniques are known to those skilled in the art, but we stress that a temperature compensation technique such as illustrated in FIGS. 4B-D will always be necessary to some degree.

Furthermore, one skilled in the art will recognize that a vibrating structure and microfluidic channel may be manufactured from numerous layers of materials, each of which may have a different thermal (and other) expansivities. When operating in an environment having a temperature fluctuation, these differing thermal expansion coefficient between layers of materials may result in thermal stress and a subsequent decrease in accuracy of the device. In lieu of this, when operating in an environment having a substantial temperature differential capable of inducing thermal stress in the resonating element, the aforementioned cantilevered device may be employed to avoid such thermal stress issues by limiting attachment to a single channel wall.

Additionally, the size and orientation of the resonating element within the channel may be selected such that squeeze film dampening is minimized. As set forth previously, the motion of a resonating element immersed in a fluid near a solid wall requires that the fluid found between the element and the wall be displaced during each oscillation. The energy needed to displace this fluid near the wall imposes an additional loss on resonator, thereby changing the resonance of the resonating element. In the present invention, squeeze film damping effects are minimized by both size and orientation of the resonating element such that the resonating element is separated from any nearby wall by a distance at least as large as the lateral dimension of the structure. If this rule is adhered to the resonance of the element is almost completely determined by the properties of the fluid rather any geometric parameters such as the distance to a nearby wall or channel edge. Furthermore, the present invention may be readily incorporated into a microfluidic platform having a fluid channel shared by a variety of microfluidic devices.

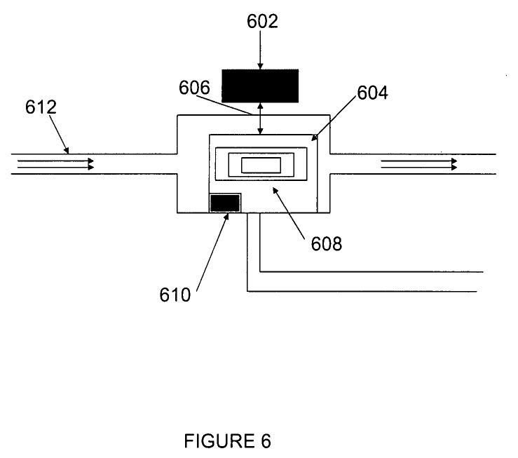

Returning to the cantilevered arrangement of a vibrating structure for use as a resonating element in the present invention, the cantilever MEMS resonating element may be fabricated using a variety of suitable techniques. One such suitable technique includes fabrication using a multi-layer lithography process that starts with a <1 0 0> Silicon On Insulator (SOI) wafer. The thickness of this device layer determines the thickness of the resulting plate, though there is an increase of a few microns due to the actuation portion associated with the resonating element, as well as the required apparatus utilized to detect the motion. Such detection of motion in the resonating element is interpreted to provide a property of the fluid moving through the fluid channel. One skilled in the art will readily recognize that numerous devices may be fabricated on each wafer, with an integrated strain gauge included in the fabrication of the resonating element. In one embodiment the strain gauge may be a polysilicon Wheatstone bridge, a coil for actuation, and a resistance based thermometer. The resonating element 606 of the present embodiment may further be packaged such that the resonating element 604 is operable in a high pressure, high temperature environment without undue detrimental effects to the measurement apparatus. In one embodiment a permanent magnet 602 such as a samarium cobalt (SmCo) magnet, is placed normal to the resonating element 606 such that the magnetic field is parallel to the arrow shown in FIG. 6. At the typical resonating element-to-magnet distance 606, the resulting measure magnetic field is sufficiently insensitive to the variations of temperature in the anticipated working temperature range. In the present embodiment the actuation element may further include a coil (608) located atop the resonating element 604, such that said coil 608 serves as an actuating device. Upon passage of a current through the coil 608 the resonating element 604 experiences a Lorentz force in the presence of the magnetic field 606 and causes the resonating element 604 to move in and out of the resonating element's 604 plane. Said motion of the resonating element 604 may further be detected by a strain gauge 610 through which a dc voltage is passed. Fluid that is to be measured is passed through channels 612.

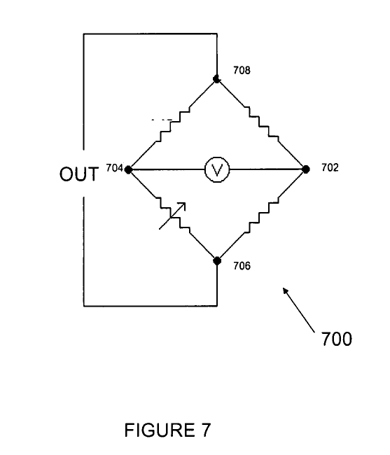

In accordance with the present embodiment an interpretation element may be in communication with the resonating element. Such communication may include the communication of motion of the resonating element as detected by said aforementioned strain gauge 610. The output of the strain gauge 610 may be delivered to a Wheatstone bridge, as understood by one skilled in the art. A suitable Wheatstone bridge arrangement is illustrated in FIG. 7 of the present invention. Motion of the resonating element 604 of FIG. 6 creates an imbalance in the arm of the Wheatstone bridge 700 of FIG. 7 Using said Wheatstone bridge arrangement 700, a constant bias voltage may be applied across one diagonal of the bridge (702,704) such that a typical amplitude of the resonating element 604 motion creates an imbalance in voltage across the opposite diagonal (708,706 of the Wheatstone bridge 700). This output voltage between 706 and 708 may be measured with a lock-in amplifier (not shown) when obtaining steady state data similar to data shown in FIG. 3A. Both the in-phase and quadrature components of the spectra may further be analyzed by the interpretation element such that the frequency and quality factor are determined from the steady state data. When using steady state data, the quality factor may be defined as frequency divided by the peak width. In an alternative embodiment of the present invention, a ring down technique may be employed such that non-steady state (i.e. transient) data is alternatively analyzed.

Such a determination of frequency and quality factory may be accomplished using, for example, regression. In what follows one such regression is described, though alternatively, though one skilled in the art will readily recognize that more refined models may be employed based upon the anticipated operating conditions and the desired accuracy. In the present embodiment, regression on spectra from the strain gauge is performed by algorithms such as those of J. B. Mehl and herein incorporated by reference, to reliably measure the resonance frequency and quality factor.

For example, regression approaches may be utilized to measure the background-subtracted peak amplitude, width, frequency (f), and quality factor (q), necessary for interpretation by the interpretation element to provide a parameter of the fluid in the fluid channel. Using a regression approach such as this yields, a complex function where u refers to the in-phase component, v the quadrature component, and i is the square root of negative one.

$$u ( f ) + i v ( f ) = \frac{Af}{( {f}^{2} - {F}^{2} )} + B + C ( f - {f}_{0} ) \qquad ( 1 )$$

The three complex parameters A, B, and C are determined by regression and are used to isolate the resonant signal. F is defined as the sum of f₀ and ig₀, the former corresponding to the resonance frequency (frequency of maximum amplitude) and the latter to the half peak width of the square of the amplitude at half height respectively. One skilled in the art will appreciate the use of regression by an interpretation element to measure a parameter of a fluid is one suitable approach and is not intended to be limiting in scope of the present invention. For example, numerous alternative approaches by the interpretation element may be utilized including an empirical approach or physical approach as understood by one skilled in the art.

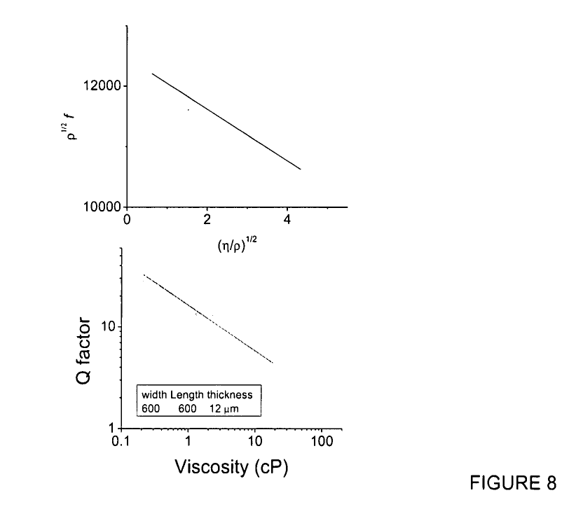

Using an empirical approach may include the testing of the measurement apparatus in a large variety of fluids with known properties (such as density and viscosity) such that a relationship of measured parameters and parameters of the fluid in a fluid channel can be observed. One such observation is illustrated in FIG. 8, where viscosity vs. quality is plotted in a log-log graph. As understood by one skilled in the art, a power law behavior of viscosity with respect to quality factor is observed, resulting in the use of the following relation that could be used as a zeroth order approximation:

$$η = {{k}_{1} ( \frac{1}{q} - \frac{1}{{q}_{p = 0}} )}^{{k}_{2}} \qquad ( 2 )$$

where qₚ₌₀ is the quality factor measured for the device under vacuum and corresponds to internal losses. The constants (k₁, k₂) are determined from regression.

Similarly, by plotting the product of the frequency and the square root of density as a function of the square root of viscosity divided by density a trend in accordance with the following equation develops:

$$ρ = {\frac{1}{{ω}^{2}} [ {k}_{4} + {{k}_{3} ( \frac{η}{ρ} )}^{1 / 2} ]}^{2} \qquad ( 3 )$$

Here ω=2πf. Again regression can be used to solve for both k₃ and k₄.

As set forth prior, a physical approach may be utilized by the interpretation element to provide at least one parameter of a fluid moving in a fluid channel. Such a physical approach to interpretation by an interpretation element has been attempted before. This prior work by Landau and Lifshitz is limited to the analysis of the non-steady motion of a sphere of radius R moving through a viscous fluid, both in the low and high frequency limit. In contrast, when the interpretation element uses a physical approach to solving for at least one parameter, fluid flow within the viscous penetration depth δ from the sphere will be rotational (non-zero curl) where as at greater distances flow will be potential-like. As used herein, δ is defined as:

$$δ = \sqrt{\frac{2 η}{ρ ω}}$$

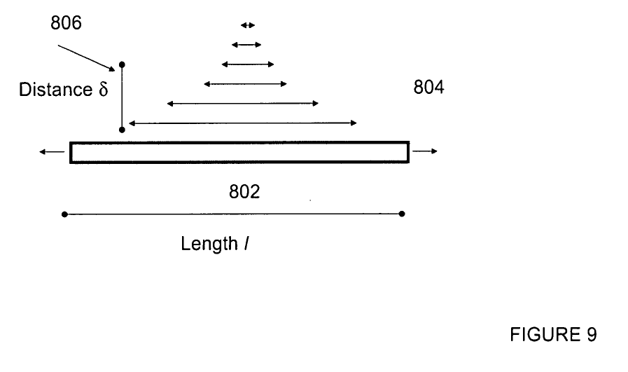

Using the current approach to provide at least one parameter by an interpretation element, a transition from low frequency behavior to high frequency behavior occurs when the viscous penetration depth δ is smaller than the relevant dimension l of the object. FIG. 9 shows an illustration of δ and l. Here the plane-like object 802, which oscillating with in-plane motion horizontally, is of length l. When immersed in a fluid its motion produces oscillatory velocity waves 804 that propagate into the fluid with an amplitude that decreases exponentially. The length at which the amplitude has decreased to e⁻¹ of the amplitude seen at the surface of the object is typically referred to as the viscous penetration depth 806 δ. The aforementioned transition from low to high frequency is satisfied when the following relation holds:

l²ω>>η/ρ (5)

For the purpose of clarity in explaining the present invention, the left hand side of equation (5) will be assumed to be on the order of 200 cm²/s. For a fluid of viscosities 1 cP the right hand side of Eq. 5 is about 10⁻² cm²/sec. For a fluid of 100 cP the right hand side of Eq. 5 is about 1 cm²/sec. In view of this, the resonating element of the present invention thereby satisfies the above constraint and furthermore is confirmed that the motion of the resonating element of the present application operates in the high frequency regime.

In accordance with Landau, L. D.; Lifshitz, E. M. 1959 Fluid Mechanics, Pergamon Press., the forces acting on the resonating element of the present invention due to its immersion in a fluid within a fluid channel is proposed to be

$${c}_{1} 3 π {R}^{2} \sqrt{2 η ρ / ω} ( 1 + \frac{2 R}{9 δ} ) \ddot{x} + {c}_{3} 6 π η r ( 1 + \frac{R}{δ} ) \dot{x} \qquad ( 6 )$$

In the Eq. 6 recited above, the first term corresponds to the inertia of the displaced fluid (added mass) and the second to the dissipation. (c₁, c₃) are unitless coefficients introduced to account for shape factors and \dot{x} and \ddot{x} correspond to the first and second time derivatives of x, the position of the sphere of radius R with respect to time. In the case where 2R>>9δ this can be further approximated by dropping the terms of order unity. However, δ is of order 100 microns in a fluid of viscosity 100 cP and the resonating element has an effective R of order 1000 microns. Since the ratio of R to δ is not several orders of magnitude, the higher order terms in equation, the higher order terms in equation (6) are included for higher precision.

Using the equation of motion for a damped, driven oscillator, commonly known to those skilled in interpretation where f_{f}(x,t) is the driving force:

\ddot{x}+2β\dot{x}+ω₀²x=f_{f}(x,t)/mₑ (7)

In the above equation x is defined once more as position and:

$$\begin{matrix}{ω}_{0}^{2} = k / {m}_{e} & ( 8 ) \\ {m}_{e} = {m}_{0} + 3 {c}_{3} π {R}^{2} \sqrt{2 η ρ / ω} ( 1 + \frac{2 R}{9 δ} ) & ( 9 ) \\ β = \frac{1}{2 {m}_{e}} ( 6 {c}_{1} π η R ( 1 + R / δ ) ) & ( 10 )\end{matrix}$$

where m₀ is the mass of the resonating element and mₑ is the mass of the resonating element plus the fluid that moves with it. In accordance with one embodiment of the present invention, the resonating element may be a cantilevered plate, wherein the above equations remain valid.

The measured spectrum D(ω) can then be calculated from:

$$D ( ω ) = \frac{A}{\sqrt{{( {ω}_{0}^{2} - {ω}^{2} )}^{2} + 4 {ω}^{2} {β}^{2}}} \qquad ( 11 )$$

where the quality factor is once more defined as the resonant frequency divided by the peak width, or in this case, ω/(2β). This spectrum applies to the steady state approach, but one skilled in the art will readily recognize that the aforementioned approach can be readily applied to the processing of transient data.

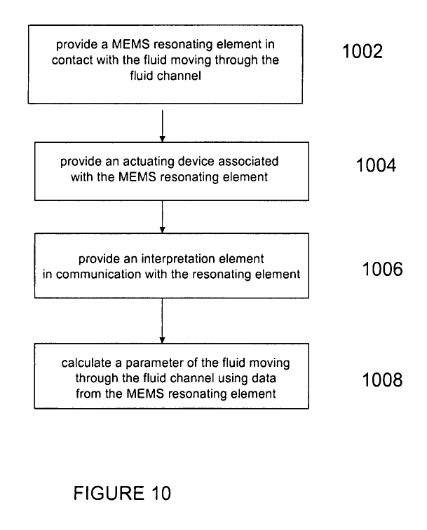

FIG. 10 is a flowchart illustrating the steps necessary in practicing one embodiment of the present invention. In accordance with step 1002, a MEMS resonating element in contact with the fluid moving through the fluid channel is first provided. As set forth previously this resonating element may take numerous sizes and shapes and may be sized and orientated to minimize the effects of squeeze film dampening. An actuating element associated with the MEMS resonating element is further provided (1004) wherein the actuating element is capable of moving the resonating element. One skilled in the art will readily recognize that numerous actuating element may be used herein, including but not limited to localized heating, piezoelectric effect or electromagnetic actuating elements. In accordance with step 1006, an interpretation element in communication with the resonating element if further provided. This interpretation element may communicate with the resonating element using a variety of techniques understood by one skilled in the art. For example, the communication between interpretation element and resonating element may be an electrical communication link, and optical link or an acoustic link. Suck links are a non-exhaustive sampling of appropriate means and are not intended to limit the scope of the present invention. Additionally, the communication between resonating element and interpretation element may further be wired in nature or wireless in nature, for example, as understood by one skilled in the art. Additionally, the elements recited in the present embodiments of the current invention may be located remotely from each other, may be co-located, or may be some combination thereof. In accordance with step 1008, the interpretation element further calculates a parameter of the fluid moving through the fluid channel based upon data from the resonating element following actuation by the actuating element.

Ultimately, the zeroth order or inviscid model must be modified to include viscous effects so that the working equations are coupled by describing the motion with the equation of continuity and the Navier-Stokes equations. Here we merely allude to a result that will be published in the future, where this will be done by modeling the flow using Stokeslets. Such methods have previously been used to analyze the swimming motions of microscopic organisms such as flagella. A numerical method for computing Stokes flows using Stokeslets has been described by Cortez. In ref Error! Bookmark not defined. a general case of Stokes flows driven by external forces was discussed. In principle, this method can be applied to any moving body interacting with fluid. However, we anticipate that the zeroth order model, which assumes density and viscosity can be represented by independent equations, is probably not a significant source of error and will provide estimates of density and viscosity for the fluids studied over the density range (619 and 890) kg·m−3 and viscosities between (0.205 to 0.711) mPa·s because Cᵢ with i=1, 2, and 3 are determined with a fluid of viscosity and density that includes these ranges. Manrique de Lara and Atkinson have proposed an alternative model (see Manrique de Lara, M.; Atkinson, C. Theoretical model on the interaction of a vibrating beam and the surrounding viscous fluid with applications to density and viscosity sensors. Sensors, 2004. Proceedings of IEEE Oct. 24-27, 2004 pp. 828-831.)

In addition to these devices, there are numerous applications of cantilever beams (developed from the devices used in atomic force microscopy) to the measurement of density and viscosity.

The foregoing description is presented for purposes of illustration and description, and is not intended to limit the invention in the form disclosed herein. Consequently, variations and modifications to the inventive parameter measurement systems and methods described commensurate with the above teachings, and the teachings of the relevant art, are deemed within the scope of this invention. These variations will readily suggest themselves to those skilled in the relevant oilfield, fluid analysis, and other relevant industrial art, and are encompassed within the spirit of the invention and the scope of the following claims. Moreover, the embodiments described (e.g., a resonating element, actuation device and interpretation element) are further intended to explain the best mode for practicing the invention, and to enable others skilled in the art to utilize the invention in such, or other, embodiments, and with various modifications required by the particular applications or uses of the invention. It is intended that the appended claims be construed to include all alternative embodiments to the extent that it is permitted in view of the applicable prior art.

We claim:

1) A measurement apparatus, for providing at least one parameter of a fluid moving through a fluid channel, comprising:
a MEMS resonating element, wherein said resonating element is in contact with the fluid moving through the fluid channel,
an actuating device associated with the MEMS resonating element, and
an interpretation element, wherein said interpretation element is in communication with said MEMS resonating element and provides a parameter of the fluid moving through the fluid channel based upon data from the MEMS resonating element upon actuation by the actuating device.

2) The measurement apparatus of claim 1, wherein said at least one parameter is fluid density.

3) The measurement apparatus of claim 1, wherein said at least one parameter is fluid viscosity.

4) The measurement apparatus of claim 1, wherein said actuating device is a localized heating device.

5) The measurement apparatus of claim 1, wherein said actuating device is an electromagnetic field.

6) The measurement apparatus of claim 1, wherein said actuating device is a piezoelectric actuator.

7) The measurement apparatus of claim 1, wherein said data from the resonating element is steady state data.

8) The measurement apparatus of claim 7, wherein said steady state data is resonant frequency data and quality factor data.

9) The measurement apparatus of claim 1, wherein said data from the resonating element is transient data.

10) The measurement apparatus of claim 9, wherein said transient data is ring down data.

11) The measurement apparatus of claim 1, wherein said fluid channel is a microfluidic channel.

12) The microfluidic channel of claim 11, wherein said channel further comprises a separator disposed before the measurement apparatus, wherein the separator is capable of removing at least a portion of the aqueous component of the fluid moving through the channel.

13) The measurement apparatus of claim 1, wherein said resonating MEMS element is a cantilever MEMS device.

14) The measurement apparatus of claim 1, wherein said resonating MEMS element is a torsional beam MEMS device.

15) The measurement apparatus of claim 1, wherein said resonating MEMS element is a double clamped beam MEMS device.

16) The measurement apparatus of claim 1, wherein said resonating MEMS element is selected and orientated to minimize the effect of squeeze film dampening on the resonating element.

17) The measurement apparatus of claim 1, wherein said resonating MEMS element is selected and orientated to minimize temperature effects.

18) The measurement apparatus of claim 1, wherein said resonating MEMS element is selected and orientated to minimize pressure effects.

19) The apparatus of claim 1, wherein said apparatus may be incorporated into a microfluidic platform.

20) A method for providing at least one parameter of a fluid moving through a fluid channel, said method comprising the steps of:
providing a MEMS resonating element, wherein said resonating element is in contact with the fluid moving through the fluid channel;
providing an actuating device associated with the MEMS resonating element;
providing an interpretation element, wherein said interpretation element is in communication with said MEMS resonating element
calculating within said interpretation element a parameter of the fluid moving through the fluid channel based upon data from the MEMS resonating element upon actuation by the actuating device.

21) The method of claim 20, wherein said at least one parameter is fluid density.

22) The method of claim 20, wherein said at least one parameter is fluid viscosity.

23) The method of claim 20, wherein said actuating device is a localized heating device.

24) The method of claim 20, wherein said actuating device is an electromagnetic field.

25) The measurement apparatus of claim 1, wherein said actuating device is a piezoelectric actuator.

26) The method of claim 20, wherein said data from the resonating element is steady state data.

27) The method of claim 26, wherein said steady state data is resonant frequency data and quality factor data.

28) The method of claim 20, wherein said data from the resonating element is transient data.

29) The method of claim 20, wherein said fluid channel is a microfluidic channel.

30) The microfluidic channel of claim 29, wherein said channel further comprises a separator disposed before the measurement apparatus, wherein the separator is capable of removing at least a portion of the aqueous component of the fluid moving through the channel.

31) The method of claim 20, wherein said resonating MEMS element is a cantilever MEMS device.

32) The method of claim 20, wherein said resonating MEMS element is a torsional beam MEMS device.

33) The method of claim 20, wherein said resonating MEMS element is a double clamped beam MEMS device.

34) The method of claim 20, further comprising the step of selecting and orientating the resonating MEMS element to minimize the effect of squeeze film dampening on the resonating element.

35) The method of claim 20, wherein said resonating MEMS element is selected and orientated to provide temperature compensation.

36) The method of claim 20, wherein said resonating MEMS element is selected and orientated to provide pressure compensation.
